(19) United States
(12) Patent Application Publication
(10) Pub. No.: US 2010/0309274 A1
(43) Pub. Date: Dec. 9, 2010

(54) KEYBOARD THERMAL TRANSFER PRINTER AND METHOD FOR OPERATING THE SAME

(76) Inventor: KUO-CHENG HUANG, Wu-Feng Hsiang (TW)

Correspondence Address: KUO-CHENG HUANG, NO. 2, LANE 146, CHUNG-CHENG ROAD, WU-FENG HSIANG, TAICHUNG COUNTY, TW

(21) Appl. No.: 12/632,751

(22) Filed: Dec. 7, 2009

Related U.S. Application Data
(63) Continuation-in-part of application No. 12/480,584, filed on Jun. 8, 2009.

(51) Int. Cl. B41J 25/304

(52) U.S. Cl. 347/197

(57) ABSTRACT

A keyboard thermal transfer printer includes a body having multiple carriers movably connected to a track and carry keypads and thermal transfer films. A transfer printing device is connected to the body and prints the thermal transfer films to the keypads when the carrier is moved to a position corresponding to the transfer printing device. A pressing device connected to a top of the body and has a pressing board with multiple pressing members, each of which includes a curved surface so as to press the thermal transfer film to the recessed area of the keypad.

The present invention is a Continuation-In-Part of applicant's patent former application Ser. No. 12/480,584, filed on Jun. 8, 2009, and relates to a keyboard thermal transfer printer and a method for operating the keyboard thermal transfer printer.

### FIELD OF THE INVENTION

### Background of the Invention

The thermal transfer printing is a way of surface treatment which is able to attach the transfer printing films with desired patterns on objects by way of thermal pressing. The transfer printing films are attached to the objects so as to increase the values or term of life of the objects.

The conventional thermal transfer printer generally includes a body, a transfer printing device, an air sucking device and at least one pressing device, wherein the body includes multiple carriers connected on a top of the body so as to position the objects and the thermal transfer films. A driving device is used to drive the carriers and the transfer printing device includes a heating device and a pressing head which is movable up and down. The pressing head is located on the top of the body so that when the object and the thermal transfer film are moved beneath the pressing head by the carriers, the pressing head is lowered to press the thermal transfer film on the object. The pressing device is located adjacent the pressing head and includes a roller which rolls over the surface of the object on which the thermal transfer film is attached so as to firmly connect the thermal transfer film on the object.

Besides, there are two types of the conventional thermal transfer printer and which are the straight track printer and loop track printer, wherein two carriers are located on two ends of the straight track and two pressing devices are located on two sides of the transfer printing devices. The carrier is movable back and forth between the printing device and end of the track so as to proceed the thermal transfer printing. When the carrier moves to the other end of the track, the object can be unloaded. By this arrangement, the thermal transfer printing process and the unloading process can be alternatively operated.

There are several carriers on the loop track and the carriers move along the loop track such that when any one of the carriers is moved to the transfer printing device and the pressing device, the thermal transfer printing process is proceeded on that carrier.

The conventional thermal transfer printing process attach the thermal transfer film by the roller rolling on the object, however, to the object with recessed surface, the roller cannot precisely or properly press the thermal transfer film to the object.

The present invention intends to provide a keyboard thermal transfer printer and a method for operating the keyboard thermal transfer printer, wherein a pressing board is provided and multiple pressing members are connected to the underside of the pressing board, each pressing member has a curved surface so as to match the recessed area of the keypad to firmly attach the thermal transfer film on the keypad.

### SUMMARY OF THE INVENTION

The present invention relates to a keyboard thermal transfer printer and comprises a body having multiple carriers which carry keypads and thermal transfer films. The carriers are movable along a track. A transfer printing device is connected to the body and prints the thermal transfer films to the keypads when the carrier is moved to a position corresponding to the transfer printing device. A pressing device is connected to a top of the body and driven by a lifting device, the pressing device has a pressing board connected to an underside thereof and multiple pressing members are connected to the pressing board. Each pressing member includes a curved surface which presses the thermal transfer film to the keypad.

A method for operating the keyboard thermal transfer printer comprises the following steps:

a loading step: loading the keypads and thermal transfer films to carrier of a body;

a printing step: driving the carrier to a position beneath a transfer printing device which prints the thermal transfer film to the keypad at a certain temperature;

a pressing step: driving the carrier to a position beneath the pressing device and the carrier being stopped, the pressing device being lowered and pressing members on the pressing board pressing the thermal transfer film to the keypad, and

a finishing step: the carrier being driven to an unloading zone and the keypad with the thermal transfer film being unloaded from the carrier.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a front view of the keyboard transfer printer of the present invention;

FIG. 2 is a top view of the keyboard transfer printer of the present invention;

FIG. 3 is an enlarged view to show the pressing members on the pressing board of the keyboard transfer printer of the present invention;

FIG. 4 shows the steps of the method of the present invention, and

FIG. 5 is a top view of a second embodiment of the keyboard transfer printer of the present invention.

### DETAILED DESCRIPTION OF THE PREFERRED EMBODIMENT

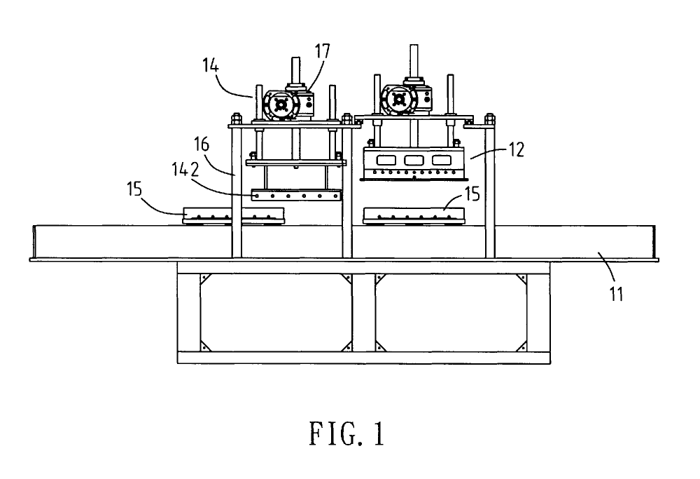

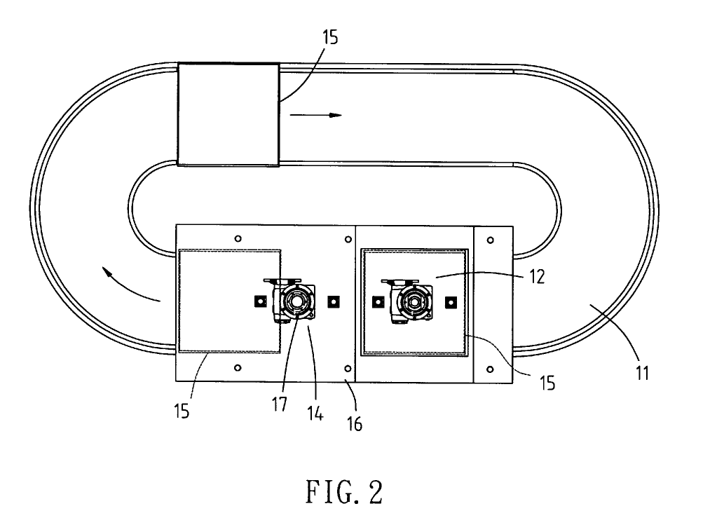

Referring to FIGS. 1 and 2, the keyboard thermal transfer printer of the present invention comprises a body 11, a transfer printing device 12 and a pressing device 14, wherein the body 11 includes a loop track and multiple carriers 15 are movable along the loop track. The carriers 15 carry keypads and thermal transfer films so as to proceed the thermal transfer printing process by being cooperated with the transfer printing device 12.

The transfer printing device 12 is connected to the body 11 and prints the thermal transfer films to the keypads at a certain temperature when the carrier 15 is moved to a position corresponding to the transfer printing device 12.

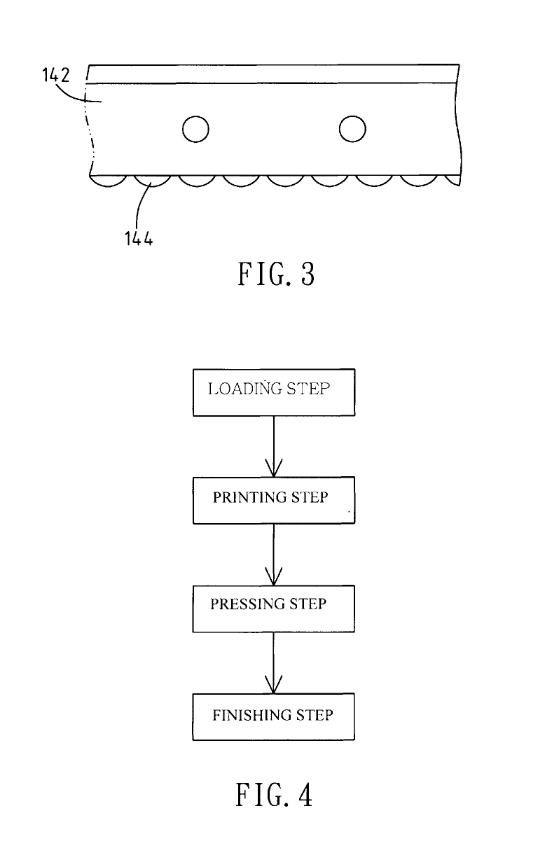

The pressing device 14 is connected to the top of the body 11 by posts 16 and driven by a lifting device 17 which is able to lift and lower the pressing device 14. Further referring to FIG. 3, the pressing device 14 has a pressing board 142 connected to an underside thereof and multiple pressing members 144 connected to the pressing board 142. Each pressing member 144 includes a curved surface which presses the thermal transfer film to the recessed area of the keypad. By the pressing members 144, the thermal transfer film can be firmly attached to the recessed area of the keypad.

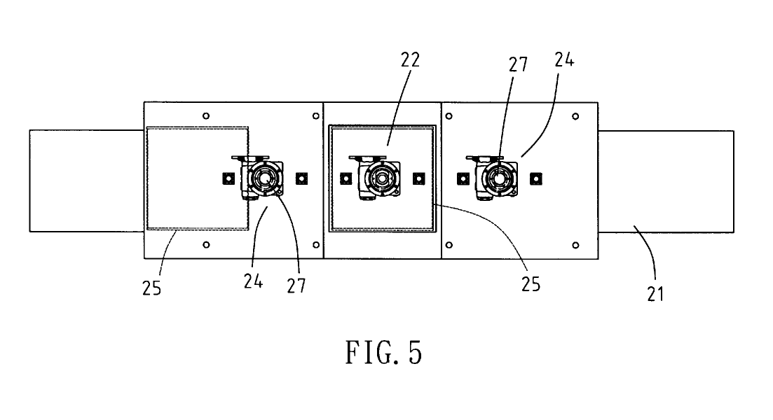

FIG. 5 shows a second embodiment of the keyboard thermal transfer printer, wherein the body 21 includes a straight track and the transfer printing device 22 is located at the middle portion of the straight track. There are two pressing devices 24 movable along the track. There are two carriers 25 and each are movable between one end of the track and a middle portion of the track, wherein the pressing devices 24 are cooperated with the lifting devices 27 are located close to the middle portion of the track. Each carrier 25 moves back and forth between one end of the straight track and the pressing device 24 corresponding thereto. When the first carrier 25 is moved to the pressing device 24 to proceed the pressing process, the other carrier 25 is moved to the end of the straight track to unload the keypads. The two carriers 25 are alternatively moved to increase the efficiency of operation.

Further referring to FIG. 4, the method for operating the keyboard thermal transfer printer of the present invention comprises the following steps:

a loading step: loading the keypads and thermal transfer films to the carrier 15 of a body 11;

a printing step: driving the carrier 15 to a position beneath the transfer printing device 12 which prints the thermal transfer film to the keypad at a certain temperature;

a pressing step: driving the carrier 15 to a position beneath the pressing device 14 and the carrier 15 being stopped, the pressing device 14 being lowered and pressing members 144 on the pressing board 142 pressing the thermal transfer film to the keypad, and

a finishing step: the carrier 15 being driven to an unloading zone and the keypad with the thermal transfer film being unloaded from the carrier 15.

While we have shown and described the embodiment in accordance with the present invention, it should be clear to those skilled in the art that further embodiments may be made without departing from the scope of the present invention.

What is claimed is:

1. A keyboard thermal transfer printer comprising:
a body having multiple carriers which are adapted to carry keypads and thermal transfer films, the carriers being movable along a track;
a transfer printing device connected to the body and adapted to print the thermal transfer films to the keypads when the carrier is moved to a position corresponding to the transfer printing device, and
a pressing device connected to a top of the body and driven by a lifting device, the pressing device having a pressing board connected to an underside thereof and multiple pressing members connected to the pressing board, each pressing member including a curved surface which is adapted to press the thermal transfer film to the keypad.

2. The printer as claimed in claim 1, wherein the track is a loop track.

3. The printer as claimed in claim 1, wherein the track is a straight track and there are two pressing devices movable along the track, each carrier is movable between one end of the track and a middle portion of the track.

4. A method for operating the keyboard thermal transfer printer, comprising the following steps:
a loading step: loading the keypads and thermal transfer films to a carrier of a body;
a printing step: driving the carrier to a position beneath a transfer printing device which prints the thermal transfer film to the keypad at a certain temperature;
a pressing step: driving the carrier to a position beneath a pressing device and the carrier being stopped, the pressing device being lowered and pressing members on the pressing board pressing the thermal transfer film to the keypad, and
a finishing step: the carrier being driven to an unloading zone and the keypad with the thermal transfer film being unloaded from the carrier.
